(19) United States
(12) Patent Application Publication
(10) Pub. No.: US 2023/0030652 A1
(43) Pub. Date: Feb. 2, 2023

(54) PROCESS FOR PREPARING LITHIUM TRANSITION METAL OXIDES

(71) Applicant: JOHNSON MATTHEY PUBLIC LIMITED COMPANY, London (GB)

(72) Inventors: Daniel CAIRNS, Billingham (GB); Paul CONNAGHAN, Billingham (GB); Andrew Rose DIAMOND, Billingham (GB)

(21) Appl. No.: 17/791,059

(22) PCT Filed: Jan. 6, 2021
(86) PCT No.: PCT/GB2021/050029

§ 371 Date: Jul. 6, 2022

(30) Foreign Application Priority Data
Jan. 7, 2020 (GB) 2000146.7

(51) Int. Cl. H01M 4/525; C01G 53/00; H01M 4/36

(52) U.S. Cl. CPC H01M 4/525; C01G 53/66; H01M 4/366; C01P 2006/40; C01P 2002/50; C01P 2002/72

(57) ABSTRACT

A process for producing a lithium transition metal oxide is provided. The process comprises pre-calcination of a transition metal precursor in the absence of a lithium source followed by a high-temperature calcination of the pre-calcined intermediate compound in the presence of a lithium source.

### TECHNICAL FIELD

The present invention relates generally to lithium transition metal oxides, processes for preparing such lithium transition metal oxides and the use of such lithium transition metal oxides as a cathode material in a secondary lithium ion battery.

### BACKGROUND

Lithium ion batteries are now ubiquitous in modern society, finding use not only in small, portable devices such as mobile phones and laptop computers but also increasingly in electric vehicles.

A lithium ion battery generally includes an anode (e.g. a graphite anode) separated from a cathode by an electrolyte, through which lithium ions flow during charging and discharging cycles. The cathode in a lithium ion battery may include a lithium transition metal oxide, for example lithium nickel oxide, lithium cobalt oxide, lithium manganese oxide, or mixed lithium transition metal oxides including two or more transition metals. The addition of other metal elements, such as magnesium, to the lithium transition metal oxide composition has been found to improve electrochemical performance.

Lithium transition metal oxide battery materials are typically manufactured by calcining a mixture of (i) transition metal oxide precursor (which is typically a transition metal hydroxide or oxyhydroxide) and (ii) lithium source, to simultaneously lithiate the precursor and oxidise the material, thereby forming the lithium transition metal oxide.

For example, WO 2017/189887 (CAMX Power LLC) describes the formation of a lithium transition metal oxide using a process comprising mixing a precursor hydroxide comprising an atomically mixed combination of 90.2 at % Ni, 7.8 at % Co, and 2.0 at % Mg with lithium hydroxide and then calcining the mixture at 450° C. for 2 hours and then at 680° C. or 700° C. for 6 hours (Example 1).

LiOH is commonly used as a lithium source compound in the manufacture of lithium transition metal oxide cathode materials, particularly those which contain low levels of manganese or do not contain any manganese, since lithium carbonate is not a suitable lithium source for such materials. However, LIOH disadvantageously has a melting point of ca. 450° C. Thus, when it is used as a lithium source in processes for preparing lithium transition metal oxides cathode materials, molten LIOH may be formed leading to processing difficulties and incomplete reaction. This may be a particular issue when the calcination comprises holding at a temperature around the lithium hydroxide melting point. Melting of LIOH can lead to interruption of the calcination process so that process equipment can be cleaned or even replaced. In particular, this means that LiOH is inconvenient as a lithium source where calcination is carried out in a rotary furnace, since melting of the LIOH causes clogging of the furnace. Typically, therefore, furnaces with a static bed of material (e.g. a static furnace or tunnel furnace such as a roller hearth kiln (RHK)) have to be used for processes involving calcination with LiOH. However, there are drawbacks to this approach, since static bed furnaces provide much slower temperature ramping and less efficient oxygen transfer to the reaction mixture during the oxidation reaction. Furthermore, tunnel furnaces require a large plant footprint and the use of ceramic saggars (crucibles) which are expensive and have a limited operational lifetime, increasing operational costs.

There remains a need for improved calcination processes. The present invention has been developed to overcome one or more of the above problems.

### SUMMARY OF THE INVENTION

The present inventors have surprisingly found that lithium transition metal oxide cathode materials can successfully be prepared by a process in which an initial calcination step is carried out on a transition metal precursor in the absence of a lithium source, followed by a subsequent high-temperature calcination in the presence of lithium source.

Surprisingly, the lithium migrates successfully into the pre-calcined intermediate, and electrochemically active lithium transition metal oxide is successfully formed as demonstrated in Examples 1a and 1b below. The materials formed by this new process show excellent specific capacity and capacity retention properties.

Accordingly, in a first preferred aspect the present invention provides a process for preparing a lithium transition metal oxide, the process comprising:

(a) pre-calcination of a transition metal precursor in the absence of a lithium source to form a pre-calcined intermediate compound, the transition metal precursor comprising nickel, cobalt and magnesium; followed by

(b) high-temperature calcination of the pre-calcined intermediate compound in the presence of a lithium source.

The transition metal precursor optionally includes at least one further transition metal. It may include one or more additional metals selected from Na, K, Ca and Al. Typically, the transition metal precursor is a transition metal hydroxide or oxyhydroxide.

By carrying out the pre-calcination step in the absence of lithium source, the process of the present invention provides significantly more flexibility regarding the calcination equipment which can be used, as discussed in more detail below.

In a second aspect, the present invention provides a pre-calcination process for preparing a pre-calcined intermediate compound, the process comprising calcination of a transition metal precursor comprising nickel, cobalt and magnesium in the absence of a lithium source.

A third aspect of the invention is a lithium transition metal oxide compound obtained or obtainable by a process according to the first aspect.

A fourth aspect of the invention is a pre-calcined intermediate compound obtained or obtainable by a process according to the second aspect.

A fifth aspect of the invention is the use of a lithium transition metal oxide compound according to the third aspect in the cathode of a lithium ion battery.

A sixth aspect of the invention is a lithium ion battery comprising a lithium transition metal oxide compound according to the third aspect.

A seventh aspect of the invention is an electric vehicle comprising a lithium ion battery according to the seventh aspect.

Any sub-titles herein are included for convenience only and are not to be construed as limiting the disclosure in any way.

### BRIEF DESCRIPTION OF THE DRAWINGS

FIG. 1 shows an XRD pattern of the material produced in Example 1a after high temperature calcination.

FIG. 2 shows an XRD pattern of the material produced in Example 1b after high temperature calcination.

### DETAILED DESCRIPTION

Preferred and/or optional features of the invention will now be set out Any aspect of the invention may be combined with any other aspect of the invention unless the context demands otherwise. Any of the preferred and/or optional features of any aspect may be combined, either singly or in any combination, with any aspect of the invention unless the context demands otherwise.

The present invention involves pre-calcination of transition metal precursor in the absence of a lithium source. Pre-calcination in the absence of a lithium source provides a number of advantages.

For example, since the lithium source is not present in the pre-calcination step, there is more choice regarding the furnace which can be used for this step. For example, it is possible to carry out this step in a rotary furnace. Rotary furnaces offer improved temperature ramping and more efficient oxygen transfer to the materials than alternative furnaces which have a static bed of material to be calcined (such as static furnaces and tunnel furnaces (e.g. roller hearth kilns) which require the use of a calcination vessel such as a saggar. Additionally, by transferring part of the calcination process into a furnace other than a tunnel furnace, the overall residence time in a tunnel furnace is reduced, resulting in increased plant throughput, a reduced plant footprint and/or reduced operational cost.

However, the pre-calcination process may suitably be carried out in any furnace known in the art, for example a static kiln (such as a tube furnace or a muffle furnace), a tunnel furnace (in which static beds of material are moved through the furnace, such as a roller hearth kiln or push-through furnace), or a rotary furnace (including a screw-fed or auger-fed rotary furnace). The furnace used for pre-calcination is typically capable of being operated under a controlled gas atmosphere.

The pre-calcination process is preferably performed in a rotary furnace. The rotary furnace may be a batch or continuous rotary furnace. The rotary furnace may be fed by a screw feeder, e.g. from a hopper.

The gas atmosphere of the furnace may be provided by supplying gas to the calciner in a co-current or counter-current fashion, preferably counter current.

The transition metal precursor may be fed to the furnace by means of a screw feeder, e.g. from a hopper. The pre-calcined intermediate may be collected in a receiving vessel, for example a metal container. The receiving vessel may be capable of being isolated from the external atmosphere, which permits the receiving vessel containing the pre-calcined intermediate to be removed from the furnace while maintaining a controlled gas atmosphere. Suitable rotary furnaces are available from Harper and from Nabertherm.

The pre-calcination process is typically carried out under a carbon dioxide (CO₂) free atmosphere. For example, the atmosphere may be carbon dioxide free air, which may be a mixture of oxygen and nitrogen. Alternatively, the carbon dioxide free atmosphere may be oxygen (e.g. pure oxygen). Preferably, the atmosphere is oxidising. As used herein, the term “carbon dioxide free” or “CO₂ free” is intended to include atmospheres including less than 100 ppm CO₂, less than 50 ppm CO₂, less than 20 ppm CO₂, or less than 10 ppm CO₂. These CO₂ levels may be achieved by using a CO₂ scrubber to remove CO₂.

The pre-calcination process typically includes a heating stage during which the temperature is increased, and a hold phase during which the temperature is maintained at an elevated level. The hold phase of the pre-calcination is typically performed at a temperature of at least 275° C., at least 290° C., at least 300° C., at least 320° C., at least 330° C. or at least 350° C. The hold phase of the pre-calcination is typically performed at a temperature of 600° C. or less, 550° C. or less, 525° C. or less, 500° C. or less, or 475° C. or less. For example, the hold phase of the pre-calcination may be performed at a temperature in the range of 275 to 600° C., 290 to 550° C., 300 to 500° C., 320 to 450° C., or 330 to 450° C.

The hold phase of the pre-calcination is typically performed for a period of 50 minutes or more, 60 minutes or more, 70 minutes or more, or 80 minutes or more. The hold phase of the pre-calcination is typically performed for a period of 5 hours or less, 4 hours or less, or 3 hours or less. For example, the hold phase of the pre-calcination may be carried out for between 1 and 4 hours, such as between 1.5 and 3 hours.

For example, the pre-calcination may be carried out at a temperature in the range from 300° C. to 500° C. for a period of 1 to 3 hours.

During the heating phase of the pre-calcination, the temperature may be increased at a rate of 1° C./min to 20° C./min, for example 2° C./min to 10° C./min, such as 3° C./min to 8° C./min.

As a result of the pre-calcination, the pre-calcined intermediate compound has a low water content. The low water content of the pre-calcined intermediate compound improves the efficiency of the high-temperature calcination step. Furthermore, the low water content of the pre-calcined intermediate compound results in a reduction of the occurrence of ‘burping’ (i.e. sudden evaporation of water during high temperature calcination which can violently disturb the material being calcined resulting in ejection from the bed). This is particularly advantageous when the high-temperature calcination step is carried out in a furnace using a static bed of material, such as a static furnace or tunnel furnace (e.g. roller hearth kiln or push-through furnace), and may permit increased loading of material in the static bed (e.g. increased saggar loading in a roller hearth kiln) resulting in increased throughput.

The process for making a lithium transition metal oxide of the present invention includes a high-temperature calcination step, in which the pre-calcined intermediate is calcined in the presence of the lithium source. The high-temperature calcination step may be carried out directly after the pre-calcination step or following one or more additional processing steps carried out on the pre-calcined intermediate. It may be preferred that the high-temperature calcination step is carried out directly after the pre-calcination step.

The lithium source may be combined with the pre-calcined intermediate before or during the high-temperature calcination step. The pre-calcined intermediate may be blended with the lithium source to provide a homogeneous mixture by any suitable means, for instance by using a powder mixer such as a Nauta, Turbula or ribbon mixer. For example, a Nauta conical screw mixer may be used with a screw speed of ca. 70 rpm and an arm rotation of 1 to 2 rpm for a period of 30 to 60 minutes. The skilled person will be able to select an appropriate mixer and mixing conditions to ensure adequate mixing of the lithium source with the pre-calcined intermediate.

The lithium source comprises lithium ions and a suitable inorganic or organic counter-anion. Suitably the lithium source comprises one or more lithium compounds selected from lithium carbonate, lithium oxide, lithium hydroxide, lithium chloride, lithium nitrate, lithium sulfate, lithium hydrogen carbonate, lithium acetate, lithium fluoride, lithium bromide, lithium iodide and lithium peroxide. In some embodiments, the lithium source is selected from one or more of lithium carbonate and lithium hydroxide. In some embodiments, the lithium source is lithium hydroxide. The present invention may provide particular advantages where the lithium source is lithium hydroxide. Lithium hydroxide is a particularly suitable lithium source where the lithium transition metal oxide material contains low levels of manganese, and/or does not contain any manganese. For example, the lithium transition metal oxide material may contain less than 10 mol %, less than 5 mol %, or less than 1 mol %, with respect to moles of transition metal in the lithium transition metal oxide material.

The high-temperature calcination step may be carried out in any suitable furnace known to the person skilled in the art, for example a static kiln (such as a tube furnace or a muffle furnace), a tunnel furnace (in which static beds of material are moved through the furnace, such as a roller hearth kiln or push-through furnace), or a rotary furnace (including a screw-fed or auger-fed rotary furnace). The furnace used for high-temperature calcination is typically capable of being operated under a controlled gas atmosphere. In some embodiments, it may be necessary or preferred to carry out the high-temperature calcination step in a furnace with a static bed of material, such as a static furnace or tunnel furnace (e.g. roller hearth kiln or push-through furnace). In some particular embodiments, the high-temperature calcination step may be carried out in a tunnel furnace, for example in a roller hearth kiln.

The high-temperature calcination is typically carried out at a temperature which is higher than the temperature employed in the pre-calcination step.

The high-temperature calcination typically includes a heating stage during which the temperature is increased, and a hold phase during which the temperature is maintained at an elevated level. The hold phase of the high-temperature calcination is typically performed at a temperature of at least 600° C., at least 650° C., at least 670° C. or at least 680° C. The hold phase of the high-temperature calcination is typically performed at a temperature of 1000° C. or less, 900° C. or less, 850° C. or less, 800° C. or less, or 750° C. or less. For example, the hold phase of the high-temperature calcination may be performed at a temperature in the range of 600 to 1000° C., 600 to 800° C., 650 to 800° C., 650 to 750° C., or 670 to 750° C.

The hold phase of the high-temperature calcination is typically performed for a period of 2 hours or more, 3 hours or more, 4 hours or more, 5 hours or more, or 5.5 hours or more. The hold phase of the high-temperature calcination is typically performed for a period of 20 hours or less, 10 hours or less, 8 hours or less, 7 hours or less or 6.5 hours or less. For example, the hold phase of the high-temperature calcination may be performed for between 4 and 10 hours, such as between 5 and 7 hours.

For example, the high-temperature calcination may be carried out at a temperature in the range from 600 to 800° C. for a period of 5 to 7 hours.

During the heating phase of the high-temperature calcination, the temperature may be increased at a rate of 20° C./min or less, 10° C./min or less, 8° C./min or less, or 6° C./min or less. The present inventors have found that a heating rate below 5° C./min may result in improved electrochemical properties, as demonstrated in the Examples. Accordingly, it may be preferred that the temperature is increased at a rate of 4° C./min or less, or 3° C./min or less. Typically, the heating rate will be at least 0.5° C./min or at least 1° C./min. For example, the heating rate may be in the range from 1 to 10° C./min, for example 1 to 8° C./min, or 1 to 4° C./min.

Where the high-temperature calcination is carried out in a furnace with a static bed of material, the pre-calcined intermediate may be loaded into a calcination vessel (e.g. saggar or other suitable crucible) prior to the high temperature calcination.

The high-temperature calcination is typically carried out under a carbon dioxide (CO₂) free atmosphere. For example, the atmosphere may be carbon dioxide free air, which may be a mixture of oxygen and nitrogen. Alternatively, the carbon dioxide free atmosphere may be oxygen (e.g. pure oxygen). Preferably, the atmosphere is oxidising.

In some embodiments, there may be a delay between the pre-calcination and the high-temperature calcination. The material may be cooled between the pre-calcination and the high temperature calcination.

The process of the invention includes the pre-calcination of a transition metal precursor. The transition metal precursor comprises nickel, cobalt and magnesium. The transition metal precursor may be a precipitated transition metal compound, for example it may be a co-precipitated mixed transition metal compound. Alternatively, a physical mixture of two or more transition metal compounds may be provided, (for example a mixture of nickel hydroxide, cobalt hydroxide and magnesium hydroxide). Preferably, the transition metal precursor is a mixed transition metal precursor comprising two or more transition metals. The transition metal precursor may be a transition metal hydroxide, a transition metal oxyhydroxide or a mixture thereof.

It may be preferred that the transition metal precursor comprises Co, Ni and at least one additional transition metal selected from Mn, Ti, Zr and Zn (e.g. Ti, Zr and Zn).

The transition metal precursor may comprise one or more additional metals. The one or more additional metals are typically selected from group 1, 2 or 13 metals. For instance, the one or more additional metals may be selected from Na, K, Ca, Al and combinations thereof, preferably Al.

In some embodiments, the metal component of the mixed transition metal precursor consists essentially of (or consists of) nickel, cobalt and magnesium (i.e. no other metals, or negligible amounts of other metals, are present).

In some embodiments, the transition metal precursor comprises nickel, cobalt and magnesium in the ratio NiₓCo_{y}Mg_{z}, wherein

0.8≤x≤1.0

0<y≤0.2

and 0<z≤0.1.

It may be preferred that x+y+z=1 or about 1 (e.g. 0.98≤x+y+z≤1.02).

In some embodiments, the mixed transition metal precursor comprises a mixed transition metal compound according to the formula:

NiₓCo_{y}TM_{w}M_{z}Oₐ(OH)_{b}

wherein:

0.6≤x≤1.0

0<y≤0.4

0<z≤0.1

0≤w≤0.3

0≤a≤0.1

1.7≤b≤2.0

TM is one or more selected from Mn, Ti, Zr and Zn, preferably one or more selected from Ti, Zr and Zn

and M is Mg and optionally one or more selected from Na, K, Ca and Al; or

0.8≤x≤1.0

0≤y≤0.2

0<z≤0.05

0≤w≤0.05

0≤a≤0.3

1.7≤b≤2.0

TM is one or more selected from Mn, Ti, Zr and Zn, preferably one or more selected from Ti, Zr and Zn

and M is Mg and optionally one or more selected from Na, K, Ca and Al; or

0.8≤x≤0.95

0.05≤y≤0.2

0<z≤0.05

0≤w≤0.05

0≤a≤0.3

1.7≤b≤2.0

TM is one or more selected from Mn, Ti, Zr and Zn, preferably one or more selected from Ti, Zr and Zn

and M is Mg and optionally one or more selected from Na, K, Ca and Al; or

0.8≤x≤0.95

0.05≤y≤0.2

0<z≤0.05

0≤w≤0.05

a=0

b=2

TM is one or more selected from Mn, Ti, Zr and Zn, preferably one or more selected from Ti, Zr and Zn

and M is Mg and optionally one or more selected from Na, K, Ca and Al; or

0.8≤x≤0.95

0.05≤y≤0.2

0<z≤0.05

w=0

0≤a≤0.3

1.7≤b≤2.0

and M is Mg and optionally one or more selected from Na, K, Ca and Al; or

0.8≤x≤0.95

0.05≤y≤0.2

0<z≤0.05

w=0

0≤a≤0.3

1.7≤b≤2.0

and M is Mg; or

0.8≤x≤0.95

0.05≤y≤0.2

0<z≤0.05

w=0

a=0

b=2

and M is Mg and optionally one or more selected from Na, K, Ca and Al; or

0.8≤x≤0.95

0.05≤y≤0.2

0<z≤0.05

w=0

a=0

b=2

and M is Mg.

It may be preferred that x+y+w=1 or about 1 (e.g. 0.98≤x+y+w≤1.02). It may be preferred that x+y+z+w=1 or about 1 (e.g. 0.98≤x+y+z+w≤1.05 or 1.03).

For example, the transition metal precursor may be a transition metal compound of formula Ni_{0.90}Co_{0.05}Mg_{0.05}(OH)₂, Ni_{0.90}Co_{0.06}Mg_{0.04}(OH)₂. Ni_{0.90}Co_{0.07}Mg_{0.03}(OH)₂. Ni_{0.91}Co_{0.08}Mg_{0.01}(OH)₂. Ni_{0.88}Co_{0.08}Mg_{0.04}(OH)₂, Ni_{0.90}Co_{0.08}Mg_{0.02}(OH)₂, or Ni_{0.93}Co_{0.06}Mg_{0.01}(OH)₂.

The transition metal precursor may be in particulate form. The transition metal precursor may be prepared by a process known in the art, for example by (co-)precipitation of transition metal hydroxides by the reaction of transition metal salts with sodium hydroxide under basic conditions.

Suitably, the transition metal precursor is in powder form, the powder comprising particles of precursor having a volume average particle size D₅₀ of from 2 to 50 μm, suitably 2 to 30 μm, suitably 5 to 20 μm, suitably 8 to 15 μm.

The pre-calcination is performed on the transition metal precursor in the absence of a lithium source.

The absence of a lithium source indicates that the material which undergoes pre-calcination does not contain any compound which is intended to provide the lithium in the final lithium transition metal oxide product. This does not exclude the presence of small amounts of lithium in the material for pre-calcination (e.g. in the transition metal precursor), such as any lithium present as an impurity. In some embodiments, no lithium source is intentionally added to the mixed transition metal precursor, such that the precursor contains only negligible levels of lithium which may be present as an impurity. In some embodiments, the amount of elemental lithium in the material for pre-calcination is less than 1 wt %, for example less than 0.5 wt %, less than 0.4 wt %, less than 0.3 wt %, less than 0.2 wt %, less than 0.1 wt %, less than 0.09 wt %, less than 0.08 wt %, less than 0.07 wt %, less than 0.06 wt % or less than 0.05 wt %.

The product of the high-temperature calcination is typically a lithium transition metal oxide. It typically has the layered α-NaFeO₂-type structure.

In some embodiments, the lithium transition metal oxide has a composition according to the formula:

Li_{c}NiₓCo_{y}TM_{w}M_{z}O_{2±d}

wherein:

0.6≤x≤1.0

0<y≤0.4

0<z≤0.1

0≤w≤0.1

0.9≤c≤1.1

−0.2≤d≤0.2

TM is one or more selected from Mn, Ti, Zr and Zn, preferably one or more selected from Ti, Zr and Zn

and M is Mg and optionally one or more selected from Na, K, Ca and Al; or

0.8≤x≤1.0

0<y≤0.2

0<z≤0.05

0≤w≤0.05

0.9≤c≤1.1

−0.2≤d≤0.2

TM is one or more selected from Mn, Ti, Zr and Zn, preferably one or more selected from Ti, Zr and Zn

and M is Mg and optionally one or more selected from Na, K, Ca and Al; or

0.8≤x≤0.95

0.05<y≤0.2

0<z≤0.05

0≤w≤0.05

0.9≤c≤1.1

−0.2≤d≤0.2

TM is one or more selected from Mn, Ti, Zr and Zn, preferably one or more selected from Ti, Zr and Zn

and M is Mg and optionally one or more selected from Na, K, Ca and Al; or

0.8≤x≤0.95

0.05<y≤0.2

0<z≤0.05

0≤w≤0.05

0.9≤c≤1.1

−0.2≤d≤0.2

TM is one or more selected from Mn, Ti, Zr and Zn, preferably one or more selected from Ti, Zr and Zn

and M is Mg and optionally one or more selected from Na, K, Ca and Al; or

0.8≤x≤0.95

0.05<y≤0.2

0<z≤0.05

w=0

0.95≤c≤1.05

−0.2≤d≤0.2

and M is Mg and optionally one or more selected from Na, K, Ca and Al; or

0.8≤x≤0.95

0.05<y≤0.2

0<z≤0.05

w=0

0.95≤c≤1.05

−0.2≤d≤0.2

and M is Mg and optionally one or more selected from Na, K, Ca and Al.

It may be preferred that x+y+w=1 or about 1 (e.g. 0.98≤x+y+w≤1.02). It may be preferred that x+y+z+w=1 or about 1 (e.g. 0.98≤x+y+z+w≤1.05 or 1.03).

Optionally, a coating step is carried out on the lithium transition metal oxide material obtained from the high temperature calcination.

The coating step may comprise contacting the lithium transition metal oxide with a coating composition comprising one or more coating metal elements. The one or more coating metal elements may be provided as an aqueous solution. Suitably, the one or more coating elements may be provided as an aqueous solution of salts of the one or more coating metal elements, for example as nitrates or sulfates of the one or more coating metals. The one or more coating metal elements may be one or more selected from lithium, nickel, cobalt, manganese, aluminium, magnesium, and zinc.

The coating step typically comprises the step of separating the solid from the coating composition and optionally drying the material. The separation is suitably carried out by filtration, or alternatively the separation and drying may be carried out simultaneously by spray-drying the lithium transition metal oxide and coating solution. The coated material may be subjected to a subsequent heating step.

The process of the present invention may further comprise the step of forming an electrode (typically a cathode) comprising the lithium transition metal oxide material. Typically, this is carried out by forming a slurry of the lithium transition metal oxide material, applying the slurry to the surface of a current collector (e.g. an aluminium current collector), and optionally processing (e.g. calendaring) to increase the density of the electrode. The slurry may comprise one or more of a solvent, a binder, carbon material and further additives.

The process of the present invention may further comprise constructing a battery or electrochemical cell including the electrode comprising the lithium transition metal oxide material. The battery or cell typically further comprises an anode and an electrolyte. The battery or cell may typically be a secondary (rechargeable) lithium (e.g. lithium ion) battery.

The invention will now be further described with reference to the following non-limiting Figures and Examples. Other embodiments of the invention will occur to those skilled in the art in the light of these.

### EXAMPLES

### Example 1

A commercially available mixed transition metal precursor of formula Ni_{0.90}Co_{0.08}Mg_{0.02}(OH)₂ (251.70 g) obtained from Hunan Brunp Recycling Technology Co. Ltd was transferred to a ceramic saggar at a loading of 2.4 g/cm² and charged into a Carbolite static calcination oven.

The saggar was heated to 400° C. at a rate of 5° C./min and held at this temperature for 2 hours in CO₂-free air. The resulting pre-calcined intermediate compound was then allowed to cool to 150° C. (to simulate transfer between furnaces, e.g. from a rotary furnace to a furnace with a static bed).

The pre-calcined intermediate material was then removed from the furnace, cooled to room temperature and then blended with dried and milled lithium hydroxide (66.33 g) in a Turbula mixer.

The blended pre-calcined intermediate material and lithium hydroxide mixture was then separated into two batches (Example 1a and 1b), loaded into ceramic saggars at a loading of 2.4 g/cm², and each subjected to a high temperature calcination step as described below, in CO₂-free air in a Carbolite static calcination oven.

Example 1a was heated to 700° C. at a temperature ramp of 2° C./min ramp and held at 700° C. for 6 hours. Example 1b was heated to 700° C. at a temperature ramp of 5° C./min and held at 700° C. for 6 hours. Each sample was then allowed to cool and passed through a 50 μm sieve.

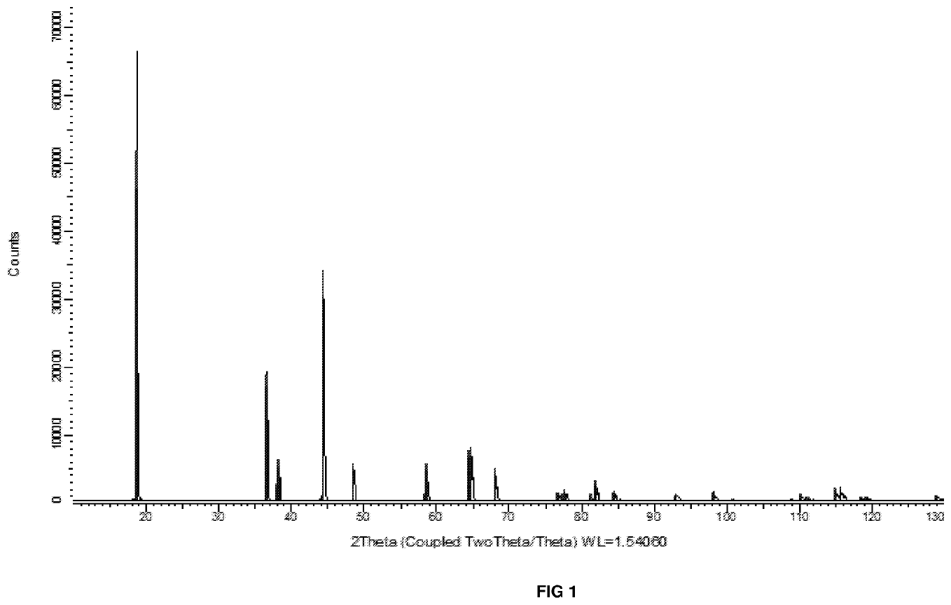

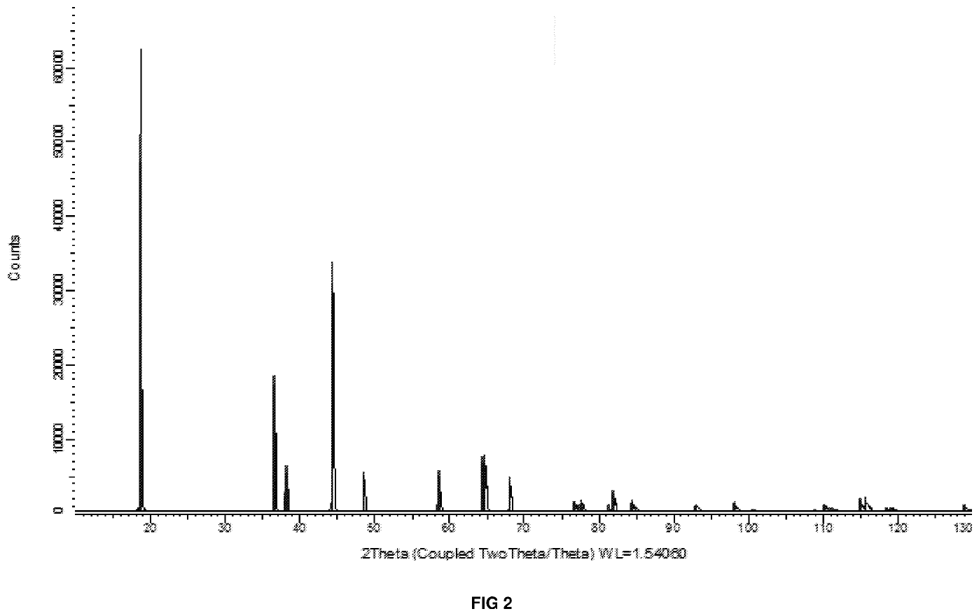

The materials produced in Examples 1a and 1b were subjected to XRD analysis, with the results shown in FIGS. 1 and 2 respectively. The XRD patterns for each sample show the presence of lithium nickel cobalt oxide with the layered α-NaFeO₂-type structure. The materials have a high degree of crystallinity as evidenced by the sharpness of the peaks. The XRD data demonstrates that the desired material was successfully prepared with a process including pre-calcination in the absence of lithium source.

### Comparative Example 1

A commercially available mixed transition metal precursor of formula Ni_{0.90}Co_{0.08}Mg_{0.02}(OH)₂ (199.19 g) obtained from Hunan Brunp Recycling Technology Co. Ltd was blended with dried and milled lithium hydroxide (52.53 g). The blend was transferred to a ceramic saggar at a loading of 2.4 g/cm² and charged into a Carbolite static calcination oven.

The saggar was heated to 450° C. at 5° C./min and held for 2 hours followed immediately by ramping at 2° C./min to 700° C. and held for 6 hours, in CO2-free air. The resulting material was allowed to cool to 150° C. and passed through a 50 μm sieve.

### Comparative Example 2

A commercially available mixed transition metal precursor of formula Ni_{0.90}Co_{0.08}Mg_{0.02}(OH)₂ (38.48 g) obtained from Hunan Brunp Recycling Technology Co. Ltd was blended with dried and milled lithium hydroxide (10.13 g). The blend was transferred to a ceramic saggar at a loading of 2.4 g/cm² and charged into a Carbolite static calcination oven.

The saggar was heated to 300° C. at a rate of 2° C./min and held at this temperature for 1 hour in CO₂-free air. The resulting compound was then allowed to cool to 150° C. (to simulate transfer between furnaces, e.g. from a rotary furnace to a furnace with a static bed).

The saggar was then heated to 700° C. at a temperature ramp of 5° C./min and held at 700° C. for 3 hours, in CO₂-free air. The material was then allowed to cool and passed through a 50 μm sieve.

### Electrochemical Testing

The materials of Examples 1a and 1b, and Comparative Examples 1 and 2, were subjected to electrochemical testing.

Electrodes were made in a 94:3:3 active:carbon:binder formulation with an ink at 65% solids. 0.6 g of SuperC65 carbon was mixed with 5.25 g of N-methyl pyrrolidone (NMP) on a Thinky® mixer. 18.80 g of active material was added and further mixed using the Thinky mixer. Finally, 6.00 g of Solef®5130 binder solution (10 wt % in NMP) was added and mixed in the Thinky mixer. The resulting ink was cast onto aluminium foils using a 125 μm fixed blade coater and dried at 120° C. for 60 minutes. Once dry, the electrode sheet was calendared in a Hohsen calendar to achieve a density of 3 g/cm3. Individual electrodes were cut and dried under vacuum overnight before transferring to an argon filled glovebox.

Coin cells were built using a lithium anode and 1M LiPF6 in 1:1:1 EC (ethylene carbonate):EMC (ethyl methyl carbonate):DMC (dimethyl carbonate)+1 wt % VC (vinylene carbonate) electrolyte. Electrodes selected had a loading of 9.0 mg/cm2 and a density of 3 g/cm3. Electrochemical measurements were taken from averages of three cells measured at 23° C., with a voltage window 3.0-4.3V.

Electrochemical testing data is shown in Table 1. The results show that the materials of both Examples 1a and 1b have excellent electrochemical performance characteristics, therefore demonstrating that a process involving pre-calcination in the absence of lithium provides excellent battery materials. The results also show that where a slower heating rate is used for the high-temperature calcination step, improved electrochemical performance is observed. Comparing the Examples and Comparative Examples demonstrates that comparable performance is achieved using a process according to the present invention and a process where lithium source is added at the outset. It is surprising that adding the lithium source later in the process is not detrimental to electrochemical performance.

TABLE 1

| | C/10 mAh/g - | C/10 mAh/g- | 50 cycle capacity |
|---|---|---|---|
| Material | cycle 2 | cycle 9 | retention (%) |
| Example 1a | 217.2 | 219.7 | 93.65 |
| Example 1b | 209.5 | 211.3 | 91.09 |
| Comparative | 219.1 | 220.2 | 93.24 |
| Example 1 | | | |
| Comparative | 217.0 | 219.5 | 92.71 |
| Example 2 | | | |

1. A process for preparing a lithium transition metal oxide, the process comprising:
(a) pre-calcination of a transition metal precursor in the absence of a lithium source to form a pre-calcined intermediate compound, the transition metal precursor comprising nickel, cobalt and magnesium; followed by
(b) high-temperature calcination of the pre-calcined intermediate compound in the presence of a lithium source.

2. The process according to claim 1 wherein the pre-calcination process includes a heating stage during which the temperature is increased and a hold phase during which the temperature is maintained at an elevated level, and wherein the hold phase of the pre-calcination is performed at a temperature in the range from 275° C. to 600° C. for between 1 and 4 hours.

3. The process according claim 1, wherein the pre-calcination is carried out at a temperature in the range from 300° C. to 500° C. for a period of 1 to 3 hours.

4. The process according to claim 1, wherein the pre-calcination step is carried out in a rotary furnace.

5. The process according to claim 1, wherein the high-temperature calcination includes a heating stage during which the temperature is increased and a hold phase during which the temperature is maintained at an elevated level, and wherein the hold phase of the high-temperature calcination is performed at a temperature in the range from 600° C. to 1000° C. for between 4 and 10 hours.

6. The process according to claim 1, wherein the high-temperature calcination is carried out at a temperature in the range from 600° C. to 800° C. for a period of 5 to 7 hours.

7. The process according to claim 1, wherein during the heating phase of the high-temperature calcination process the temperature is increased at a rate of 4° C./min or less.

8. The process according to claim 1, wherein in step (b) the pre-calcined intermediate is calcined in the presence of lithium hydroxide and/or lithium carbonate.

9. The process according to claim 1, wherein the lithium transition metal oxide does not contain manganese or contains less than 10 mol % of manganese with respect to the total moles of transition metal in the lithium transition metal oxide.

10. The process according to claim 1, wherein the transition metal precursor is a transition metal hydroxide, a transition metal oxyhydroxide, or a mixture thereof.

11. The process according to claim 1, wherein the transition metal precursor comprises Ni, Co and optionally one or more transition metals selected from Ti, Zr, Mn and Zn.

12. The process according to claim 1, wherein the transition metal precursor comprises one or more additional metals selected from group 1, 2 or 13 metals.

13. The process according to claim 1, wherein the mixed transition metal precursor comprises a mixed transition metal compound according to the formula:
NiₓCo_{y}TM_{w}M_{z}Oₐ(OH)_{b}
wherein:
0.65≤x≤1.0
0<y≤0.4
0<z≤0.1
0≤w≤0.3
0≤a≤0.1
1.7≤b≤2.0
wherein TM is one or more transition metals selected from Mn, Ti, Zr and Zn, and
wherein M is Mg and optionally one or more metals selected from Na, K, Ca and Al.

14. The process according to claim 1, wherein the lithium transition metal oxide has the layered α-NaFeO₂-type structure.

15. The process according to claim 1, wherein the lithium transition metal oxide has a composition according to the formula:
Li_{c}NiₓCo_{y}TM_{w}M_{z}O_{2±d}
wherein:
0.6≤x≤1.0
0<y≤0.4
0<z≤0.1
0≤w≤0.1
0.9≤c≤1.1
−0.2≤d≤0.2
wherein TM is one or more metals selected from Mn, Ti, Zr and Zn, and
wherein
M is Mg and optionally one or more selected from Na, K, Ca and Al.

16. The process according to claim 1, wherein a coating step is carried out on the lithium transition metal oxide material obtained from the high-temperature calcination.

17. The process according to claim 1, wherein the process further comprises the step of forming an electrode comprising the lithium transition metal oxide material.

18. The process according to claim 17, wherein the process further comprises constructing an electrochemical cell including the electrode comprising the lithium transition metal oxide material.
